(19) United States
(12) Patent Application Publication
(10) Pub. No.: US 2005/0018913 A1
(43) Pub. Date: Jan. 27, 2005

(54) APPARATUS FOR DECODING COMPRESSED IMAGES

(76) Inventors: Hsin-Jung Chuang, Taipei City (TW); Jin-Jou Chen, Taipei City (TW); Sheng-Hung Tsao, Taipei City (TW); Ming-Hsiu Chien, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/710,595

(22) Filed: Jul. 23, 2004

(30) Foreign Application Priority Data
Jul. 24, 2003 (TW) 092120173

(51) Int. Cl. G06K 9/36

(52) U.S. Cl. 382/233

(57) ABSTRACT

An apparatus for decoding compressed images is disclosed. A compressed file decoder is added in the apparatus for decreasing the load on a CPU and increasing the speed of decoding a compressed file. Furthermore, a pipeline structure is used in designing the elements of the compressed file decoder. Therefore, after a compressed file is received by the compressed file decoder, each of the elements of the compressed file decoder sequentially executes to decode the compressed file to generate a corresponding decoded image data. Hence, when displaying the image corresponding to the compressed file, the quality of image display on a TV screen can be substantially improved, and the situation in which image display idles or delays will occur less.

### BACKGROUND OF INVENTION

1. Field of the Invention

The present invention relates to an image decoding apparatus, and more specifically, to an image decoding apparatus utilized in an image player.

2. Description of the Prior Art

As technology improves, the computation ability of a CPU (central processing unit) of a computer is enhanced. Therefore, technology of image processing nowadays depends on a CPU to perform the operation of image encoding or decoding. It is well known that image processing is one kind of technology, which needs to perform a large number of computations. Hence, whether a personal computer or an image player is processing an image file, the load on a CPU is very heavy during the period of image processing.

Please refer to FIG. 1. FIG. 1 is a block diagram of an image decoding apparatus 100 utilized in a personal computer or an image player according to the prior art. The image decoding apparatus 100 comprises a central processing unit (CPU)10, a compressed file (CF)30, a frame buffer 20, a random access memory (RAM) 50, and a video encoder 40.

Generally speaking, after the CPU 10 receives the compressed file 30 (such as a JPEG (Joint Photographic Experts Group) file) stored in an optical disc (not shown), the CPU 10 gets an instruction for decoding a compressed image from the RAM 50 and then decodes the compressed file 30. During the decoding process, the CPU 10 continuously accesses data of the compressed file 30 and then stores the decoded image data of the compressed file 30 to RAM 50. Therefore, data is transmitted constantly within buses connected between the CPU 10 and the RAM 50 and the CPU 10 and the compressed file 30. After the CPU 10 finishes decoding the process of the compressed file 30, the decoded image data is transmitted from the RAM 50 to be stored into the frame buffer 20. The video encoder 40 appropriately encodes the decoded image data stored in the frame buffer 20 and outputs the encoding result to a screen of a computer or a TV (not shown in FIG. 1).

However, when displaying the compressed file 30 at a high resolution, the computation ability of the CPU 10 is limited. Therefore, decoding the compressed file 30 consumes a very long time and causes the situation in which image display on a screen of a computer or a TV idles or experiences delays. If the situation occurs in which image display idles or delays, especially on an image player that is playing images, a consumer will not likely purchase the image player.

### SUMMARY OF INVENTION

It is therefore an objective of the claimed invention to provide an image decoding apparatus for decoding a compressed file. When decoding a compressed file to generate a corresponding image, the image decoding apparatus can decrease the load on a CPU and increase the speed of decoding the compressed file. Therefore the quality of image display on a TV screen can be substantially improved, and the situation in which image display idles or delays will occur less.

According to the claimed invention, an image decoding apparatus is disclosed for decoding a compressed file. The image decoding apparatus contains a CPU which receives a compressed file; a compressed file decoder which receives the compressed file outputted from the CPU, generates a decoded image data and then encodes the decoded image data into a digital video signal; a frame buffer connected to the compressed file decoder for storing the decoded image data; and an analog video encoder which receives the digital video signal and converts the digital video signal to a TV signal.

According to the claimed invention, an image decoding apparatus is disclosed for decoding a compressed file. The image decoding apparatus contains a decoder core utilized for receiving a compressed file and producing a frame composed of a plurality of minimum coded units for the compressed file; an adjusting operation unit utilized for selecting a shown range in the frame, applying a resize operation or a rotation operation on the shown range, and then converting the shown range on which the resize operation or the rotation operation has been performed into the decoded image data; a frame buffer utilized for storing the decoded image data; and a digital video encoder utilized for reading the decoded image data stored in the frame buffer and encoding the decoded image data to generate a digital video signal.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an image decoding apparatus utilized in a personal computer or an image player according to the prior art.

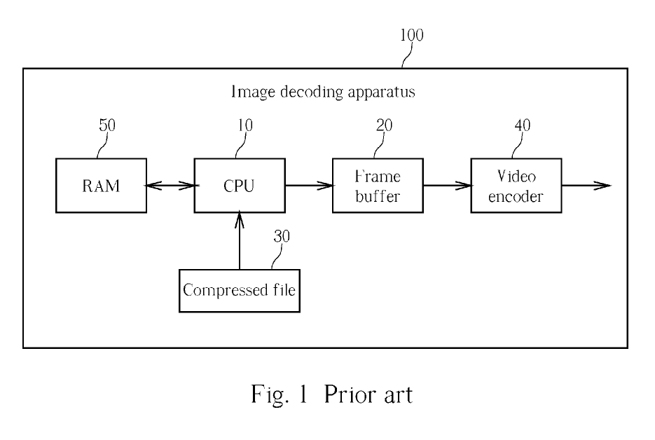

FIG. 2 is a block diagram of an image decoding apparatus utilized in an image player according to the present invention.

FIG. 3 is a block diagram of a compressed file decoder according to the present invention.

FIG. 4 is a diagram illustrating a frame.

### DETAILED DESCRIPTION

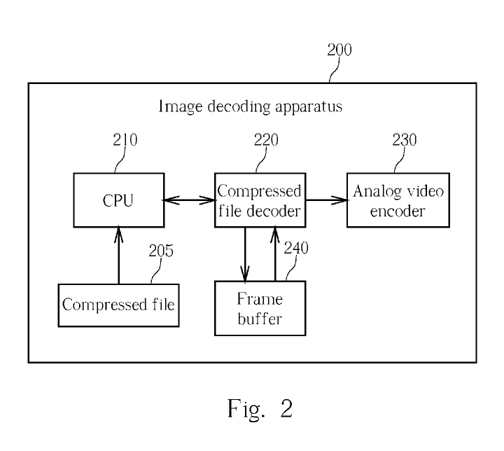

Please refer to FIG. 2. FIG. 2 is a block diagram of an image decoding apparatus 200 utilized in an image player according to the present invention. The image decoding apparatus 200 comprises a compressed file 205, a CPU 210, a compressed file decoder 220, an analog video encoder 230, and a frame buffer 240. According to an embodiment of the present invention, the compressed file decoder 220 is a JPEG decoder, and the compressed file 205 is a JPEG file.

After receiving the compressed file 205 by the CPU 210, the CPU 210 does not process the compressed file 205 and transmits the compressed file 205 to the compressed file decoder 220. The compressed file decoder 220 converts the compressed file 205 to a decoded image data, and then stores the decoded image data into the frame buffer 240. The compressed file decoder 220 also converts the decoded image data stored in the frame buffer 240 to a digital video signal and transmits the digital video signal to an analog video encoder 230. The analog video encoder 230 receives the digital video signal outputted by the compressed file decoder 220 and converts the digital video signal into a TV signal that conforms to the NTSC or the PAL standard. Then, the TV signal is transmitted to a TV screen (not shown in FIG. 2) to display the image corresponding to the compressed file 205 on the TV screen.

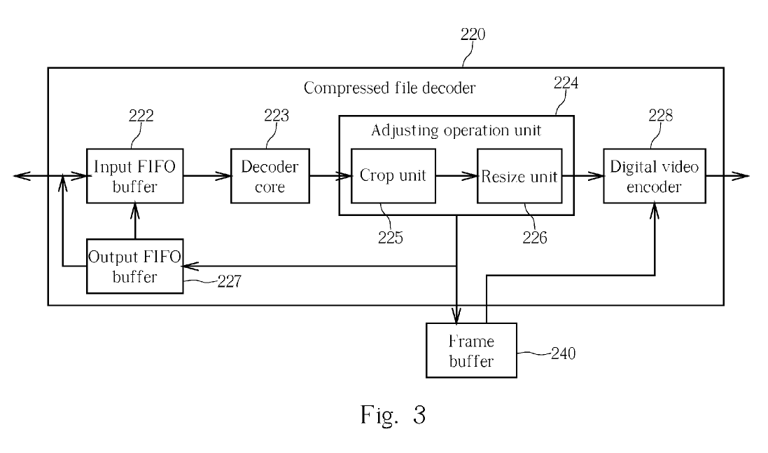

Furthermore, please refer to FIG. 3. FIG. 3 is a block diagram of the compressed file decoder 220 according to the present invention. The compressed file decoder 220 is a chip. The chip comprises an input FIFO (First In First Out) buffer 222, a decoder core 223, an adjusting operation unit 224, an output FIFO buffer 227, and a digital video encoder 228. The input FIFO buffer 222 is utilized for temporarily storing the compressed file 205. The decoder core 223 receives the compressed file 205 and decodes the compressed file 205 to generate a plurality of minimum coded units (MCU). The decoder core 223 outputs the plurality of minimum coded units to the adjusting operation unit 224. The adjusting operation unit 224 selects a shown range according to a users choice, applies a resize operation or a rotation operation on the shown range and then converts the shown range on which the resize operation or the rotation operation has been performed into a decoded image data. The decoded image data is stored in the frame buffer 240. The digital video encoder 228 encodes the decoded image data stored in the frame buffer 240 to generate and output a digital video signal. Furthermore, the output FIFO buffer 227 receives the decoded image data outputted by the adjusting operation unit 224 under the control of the CPU 210 and transmits the decoded image data back to the CPU 210.

Furthermore, the adjusting operation unit 224 comprises a crop unit 225 and a resize unit 226. The crop unit 225 is utilized for selecting the shown range. The resize unit 226 is utilized for applying a resize operation or a rotation operation on the shown range.

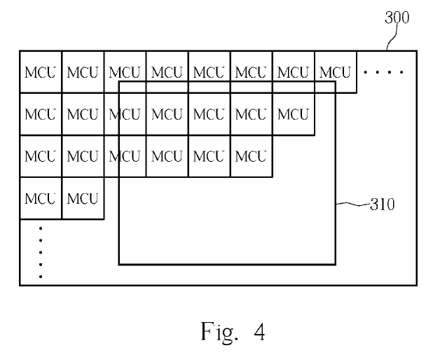

Generally speaking, when the compressed file 205 is received by the decoder core 223, the format and the parameters of the compressed file 205 are recorded along with a sampling factor in the header of the compressed file 205. The decoder core 223 generates the plurality of minimum coded units according to the sampling factor. Please refer to FIG. 3 and FIG. 4. FIG. 4 is a diagram illustrating a frame 300. The frame 300 is composed of the plurality of minimum coded units corresponding to the compressed file 205, and more specifically, the plurality of minimum coded units are arranged in order to form the frame 300, as shown in FIG. 4. Moreover, the crop unit 225 in the adjusting operation unit 224 selects a shown range 310 in the frame 300 according to the selection made by the user, and the crop unit 225 outputs the shown range 310 into the resize unit 226. The resize unit 226 applies a resize operation or a rotation operation on the shown range 310 and generates the decoded image data. Then, the decoded image data is stored in the frame buffer 240. The digital video encoder 228 reads the decoded image data stored in the frame buffer 240 and encodes the decoded image data to generate the digital video signal. The digital video encoder 228 outputs the digital video signal into the compressed file decoder 220. According to the present embodiment of the present invention, the digital video encoder 228 is an ITU-R656 digital video encoder.

According to the embodiment of the present invention, after a compressed file 205 is received by the CPU 210, the CPU 210 immediately transmits the compressed file 205 to the compressed file decoder 220. The compressed file decoder 220 decodes the compressed file 205 and outputs the digital video signal to the analog video encoder 230. The analog video encoder 230 generates the TV signal that conforms to the NTSC or the PAL standard. Then, the TV signal is transmitted to a TV screen to display the image corresponding to the compressed file 205 on the TV screen.

Therefore, according to the present invention, the input FIFO buffer 222, the decoder core 223, the adjusting operation unit 224, the output FIFO buffer 227, and the digital video encoder 228 are integrated into the compressed file decoder 220. Hence, when the compressed file 205 is decoded, the load on the CPU 210 can be substantially decreased.

Furthermore, each component of the compressed file decoder 220 has a specific function and a pipeline structure is used in designing the elements of the compressed file decoder 220. Therefore, after the compressed file 205 is received by the compressed file decoder 220, each of the elements of the compressed file decoder 202 sequentially executes to decode the compressed file 205 to generate a corresponding decoded image data. Hence, when displaying the image corresponding to the compressed file 205, the quality of image display on a TV screen can be substantially improved, and the situation in which image display idles or delays will occur less.

Moreover, the compressed file decoder 220 according to the present invention can further provide various operation modes according to a user's choice. For example, after a user selects an operation mode, the decoded image data after some operation(s) (a resize operation or a rotation operation) applied by the adjusting operation unit 224 is temporarily stored in the output FIFO buffer 227. Then the decoded image data stored in the output FIFO buffer 227 is transmitted back to the CPU 210 to be processed by the CPU 210. Or after a user selects an operation mode, the CPU 210 can directly access the decoded image data stored in the frame buffer 240.

Therefore, the present invention adds a compressed file decoder in the image decoding apparatus to decrease the load on a CPU and increase the speed of decoding a compressed file.

Those skilled in the art will readily observe that numerous modifications and alterations of the device may be made while retaining the teachings of the invention. Accordingly, that above disclosure should be construed as limited only by the metes and bounds of the appended claims.

1. An image decoding apparatus utilized for decoding a compressed file, comprising:
a central processing unit (CPU) which receives a compressed file;
a compressed file decoder which receives the compressed file outputted from the CPU, generates a decoded image data and encodes the decoded image data to generate a digital video signal;
a frame buffer connected to the compressed file decoder for storing the decoded image data; and
an analog video encoder which receives the digital video signal and converts the digital video signal into a TV signal.

2. The image decoding apparatus of claim 1, wherein the compressed file decoder provides an operation mode through which the decoded image data is transmitted back to the CPU.

3. The image decoding apparatus of claim 1, wherein the compressed file decoder provides an operation mode through which the CPU accesses the frame buffer.

4. The image decoding apparatus of claim 1, wherein the compressed file is a JPEG file.

5. The image decoding apparatus of claim 1, wherein the TV signal conforms to the NTSC standard.

6. The image decoding apparatus of claim 1, wherein the TV signal conforms to the PAL standard.

7. The image decoding apparatus of claim 1, wherein the compressed file decoder comprises:
a decoder core utilized for receiving the compressed file and producing a frame composed of a plurality of minimum coded units for the compressed file;
an adjusting operation unit utilized for selecting a shown range in the frame, applying a resize operation or a rotation operation on the shown range, and then converting the shown range on which the resize operation or the rotation operation has been performed into the decoded image data; and
a digital video encoder utilized for reading the decoded image data stored in the frame buffer and encoding the decoded image data to generate the digital video signal.

8. The image decoding apparatus of claim 7, wherein the adjusting operation unit comprises:
a crop unit utilized for selecting the shown range in the frame; and
a resize unit utilized for applying a resize operation or a rotation operation on the shown range and generating the decoded image data.

9. The image decoding apparatus of claim 7, wherein the decoder core is a JPEC decoder core.

10. The image decoding apparatus of claim 7, wherein the digital video encoder is an ITU-R656 digital video encoder.

11. An image decoding apparatus utilized for decoding a compressed file, comprising:
a decoder core utilized for receiving a compressed file and producing a frame composed of a plurality of minimum coded units for the compressed file;
an adjusting operation unit utilized for selecting a shown range in the frame, applying a resize operation or a rotation operation on the shown range, and then converting the shown range on which the resize operation or the rotation operation has been performed into a decoded image data;
a frame buffer utilized for storing the decoded image data; and
a digital video encoder utilized for reading the decoded image data stored in the frame buffer and encoding the decoded image data to generate a digital video signal.

12. The image decoding apparatus of claim 11, wherein the adjusting operation unit comprises:
a crop unit utilized for selecting the shown range in the frame; and
a resize unit utilized for applying a resize operation or a rotation operation on the shown range and generating the decoded image data.

13. The image decoding apparatus of claim 11 further comprising a CPU utilized for receiving the compressed file and transmitting the compressed file to the decoder core.

14. The image decoding apparatus of claim 11 further comprising an analog video encoder utilized for receiving the digital video signal and converting the digital video signal into a TV signal.

15. The image decoding apparatus of claim 14, wherein the TV signal conforms to the NTSC standard.

16. The image decoding apparatus of claim 14, wherein the TV signal conforms to the PAL standard.

17. The image decoding apparatus of claim 11, wherein the decoder core is a JPEC decoder core.

18. The image decoding apparatus of claim 11, wherein the digital video encoder is an ITU-R656 digital video encoder.
